(19) United States
(12) Patent Application Publication
(10) Pub. No.: US 2007/0186711 A1
(43) Pub. Date: Aug. 16, 2007

(54) Engine auxiliary drive for a motor vehicle with a toothed-gear drive

(76) Inventors: Stephan Oberle, Villingen-Schwenningen (DE); Christian Friedrich, Graz (AT)

Correspondence Address: NATH & ASSOCIATES, 112 South West Street, Alexandria, VA, 22314, US

(21) Appl. No.: 10/591,946

(22) PCT Filed: Mar. 11, 2005
(86) PCT No.: PCT/EP05/02579

§ 371 Date: Nov. 30, 2006

(30) Foreign Application Priority Data
Mar. 11, 2004 (DE) 10 2004 012 347.0

(51) Int. Cl. F16H 55/17

(52) U.S. Cl. 74/460

(57) ABSTRACT

The invention relates to an engine auxiliary drive for a motor vehicle with a toothed-gear drive, comprising a first (1) and a second gear wheel (2) with teeth flanks (11, 12), engaged with each other, whereby the teeth flanks (11, 12) on the gear wheels (1, 2) in the force transmission region (13) are embodied without involute and progress directly or almost directly from a concave region into a convex region and the first gear wheel (1) is made from plastic.

The invention relates to an engine auxiliary drive of a motor vehicle with a toothed-gear drive according to the features of the preamble of Claim 1.

The expression engine auxiliary drive is used for all drives within a motor vehicle which are not used directly for driving the wheels and thus directly for propulsion, but rather with which auxiliary equipment within the motor vehicle is driven by the engine. Such engine auxiliary drives include in particular the drives of camshafts, oil pumps or balancer shafts of combustion engines. With such balancer shafts, the vibrations which are so unpleasant, especially with four-cylinder combustion engines, can be reduced significantly.

With the known balancer shafts, inertial forces and moments of inertia are produced which counteract those produced by the combustion engine, and thus cancel them out. To that end, they are driven from the crankshaft with a certain gear ratio (1:1 or 1:2, depending on the order of the forces to be canceled) and a certain phase position.

To drive the drive shafts, a toothed-gear drive with a tooth pairing of two meshing gear wheels is usually used, in which a first gear wheel sits on the crankshaft and meshes with a second gear wheel which sits on the balancer shaft.

It is clear that with such engine auxiliary drives, and in particular with the drives for balancing shafts, enormous loads and demands on the involved gear wheel pairs regularly occur. These loads are impacts acting on the tooth flanks, which cause a pulsating surface pressure on the tooth flanks corresponding to the rotational natural frequencies and the excitation frequencies of the system (the speed of rotation of the crankshaft of a piston engine pulsates), with high peak values. These can result in destruction of the tooth flanks or breakage of the tooth base. For that reason, the gear wheels for these applications are normally made of metal, because metal gear wheels provide sufficiently high strength and thus metal gear wheels can handle the heavy loads.

It is usual with such metal gear wheels to use involute toothing, because that is easy to produce. With involute toothing, the effective profiles of the tooth flanks—i.e., the profiles of the tooth flanks that come into contact with each other when the teeth mesh and via which a transmission of force takes place—are circular involutes; that is, they describe a curve that is obtained if one constructs a tangent at all points of a circle and on the tangents removes the length of the arc from the point of contact of the tangent with the circle to a certain fixed point on the circle. On gear wheels without outside gearing, the effective profiles of involute toothing, looking outward from inside the tooth, is always convex. Typical of gear wheels of involute design is the fact that when the gear wheels roll off of each other, when viewed in cross section the contact between them is in the form of a dot. Viewed in three-dimensional space, the gear wheels roll off of each other in a linear pattern, with the line of contact being parallel to the axes of the gear wheels, if straight teeth are chosen. With helical gearing, the contact line is slightly oblique on the tooth flank.

Gear wheels with involute toothing can be made simply and precisely using the generating cut method, where a rectilinear and hence simple and inexpensive reference profile is used as a tool. Another advantage of this tooth geometry can be seen in the fact that different tooth shapes and center-to-center distances can be produced with the same tool by simply shifting the profile. In operation, gear wheels with involute toothing are distinguished by the fact that the direction and magnitude of the tooth normal force during the engagement of the teeth is constant, resulting in a constant load on the entire gearbox, in particular the gearbox bearings.

However, meshing metal gear wheels with involute toothing are distinguished by relatively severe development of noise during meshing. In addition, this development of noise is amplified if the meshing takes place under severely changing load conditions.

In addition, it is known and customary to use metal gear wheel pairs with helical gearing and with especially precisely determined tooth flank play with close tolerance in such systems. That reduces primarily the noise of meshing, but scarcely lessens the dynamic loads. Gear wheels with helical gearing are relatively expensive to produce, however, and require bearings with especially low play that are suitable for absorbing axial forces. The axial forces, for their part, also pulse, and can cause audible vibrations.

In an improved version of the above, which is described for example in JP2002-364731 A, at least one of the two gear wheels is connected to its shaft in a rotationally elastic connection, and possibly also in a way that damps torsional oscillations. This rotationally elastic connection is bulky and complex, because it must nevertheless fulfill the need for sufficient rigidity in the radial and axial directions. There must be assurance that the flank play will be precisely maintained by the helical gearing, and that the axial forces will be absorbed. Although that results in a certain uncoupling of rotation, the effect is slight because of the low stationary torque. Little change is made in the severity of the impacts between the metal flanks.

A further step in development is known from DE 199 09 191. In this instance one of the two gear wheels is made of fiber-reinforced plastic. Since the strength of a metal gear wheel was assumed, it appeared necessary to lay the fibers so that they would not be severed when the teeth were being shaped. That leads to the solution described in JP 62-101967 A, but this requires very labor-intensive placement of the reinforcing fibers in the injection mold. With this material one certainly does achieve a sound damping, and to a limited degree also vibration damping, but at least a shift into a different frequency range. But that does not eliminate the main trouble—the high, pulsating surface pressure.

Overall, the attempt with the fiber-reinforced plastic gear wheels was to largely achieve the strength of metal gear wheels. But the problem, besides the more complicated manufacturing process for such fiber-reinforced plastic gear wheels, was the high price connected with them, which makes it impossible to utilize such gear wheel pairs cost-effectively.

In addition, a worm gear is known from DE 41 07 659 A1 in which the worm and worm wheel are optimized on their frictional contact surfaces so that low-noise operation occurs. To this end the tooth bases are of concave design and the tooth tops convex, with an involute center part of the tooth (see column 3, line 7 of that document) provided between these concave and convex sections. However, the result of using the involute center part of the tooth is that at least in this involute area only a dot-shaped contact of the meshing teeth is possible. For that reason, even these previously known worm gears are not adequate for taking heavy loads over their entire meshing area.

Given this background, the object of the present invention is to create for an engine auxiliary drive of the type named at the beginning a toothed-gear drive with increased load-bearing capacity, and in particular increased dynamic load-bearing capacity, which is simple and inexpensive to produce and is nevertheless distinguished by a very long service life.

This problem is solved by a drive having the features of Claim 1.

Refinements are the subject of the subordinate claims.

The essential basis of the invention is that the tooth flanks of the gear wheels are of non-involute, or at least largely non-involute design in the force transmission area,

and go from a concave area directly to a convex area. The first gear wheel here is preferably made of homogeneous plastic, and the second gear wheel preferably of a material having a greater strength than the first gear wheel.

This approach to a solution is an intentional departure from the previously pursued line of development of heavily-loaded gear wheel pairings based on metal gear wheels. Instead, the starting point is the properties of the best-suited plastics themselves, i.e., with a view to simple production, plastics that are not fiber-reinforced and do not contain other reinforcing elements. These properties are on the one hand low static strength compared with metal, and on the other hand toughness and self-damping, which is well suited for pulsating surface pressure.

As familiar as plastic gear wheels are, use of a non-fiber-reinforced plastic for gear wheels subject to heavy dynamic loads represents a radical departure from the former direction of development and a break with the prejudice that homogeneous plastics in gear wheels are unsuitable for dynamic loads of all types. At the same time, the suitability for damping absorption of pure pressure shocks was ignored, and it was forgotten that only a small torque needs to be transferred. The low elasticity is sufficient to bring about an enlargement of the contact area under the influence of a Hertzian pressure. Because of the enlargement of the contact surface, the force is distributed over a larger area—the surface pressure drops.

The non-involute, or at least largely non-involute design of the tooth flanks in the force transmission area with convex and concave sections also brings about a further reduction of the surface pressure, because due to the small distance between the concave and the convex surface in a relatively large zone an additional substantial enlargement of the contact surface is achieved, even with low Hertzian pressure.

With the design of the tooth flanks according to the invention, the curvatures of the flank profiles over the height of the teeth are chosen so that in the force transmission area an inward curve is matched with a corresponding outward curve on the other tooth and vice versa. A planiform contact, as proposed in the present invention, has the decided advantage over linear contacts as are customary with tooth flanks of involute design as in the known art, that the load being transferred from one gear wheel to the other gear wheel is distributed over a larger area, which lowers the load on the teeth per unit of area. That reduces both the wear of the gears and the risk of overloading. Thus the loading capacity of the gear wheels increases overall. The measure according to the invention of permitting and providing no involute area at all or only the minimum necessary for meshing of the teeth achieves the high bearing and loading capability of the gearbox according to the transmission over the entire rolling contact zone. This is also supported by the choice of material.

According to one exemplary embodiment, the gear wheel with the larger diameter and a larger number of teeth, i.e., the gear for example that is coupled with the crankshaft of a combustion engine, is made of a material of greater strength than the material of the second, smaller gear.

For example, the first-mentioned gear wheel is made of steel and the smaller gear wheel is made of the homogeneous plastic according to the invention. Homogeneous plastic gear wheels have manufacturing advantages. Plastic gear wheels can be produced with the help of the inexpensive injection molding process, without need of a subsequent milling treatment.

The reduction of the area load per tooth according to the invention also enables the tooth thicknesses of the gear wheels to be optimized. Especially good optimization is achieved when the material properties of the material pairings are included. For example, according to another exemplary embodiment the tooth thicknesses of the plastic gear wheel are greater than the tooth thickness of the metal gear wheel. Reducing the tooth thicknesses in turn brings cost advantages, because material can be saved as a result.

It should be noted that the invention is usable both for a toothed-gear drive with either straight-toothed or helical-toothed spur gears as well as for worm drives with straight or helical-toothed worm wheels.

The invention is explained below in greater detail on the basis of exemplary embodiments in connection with figures. The figures show the following:

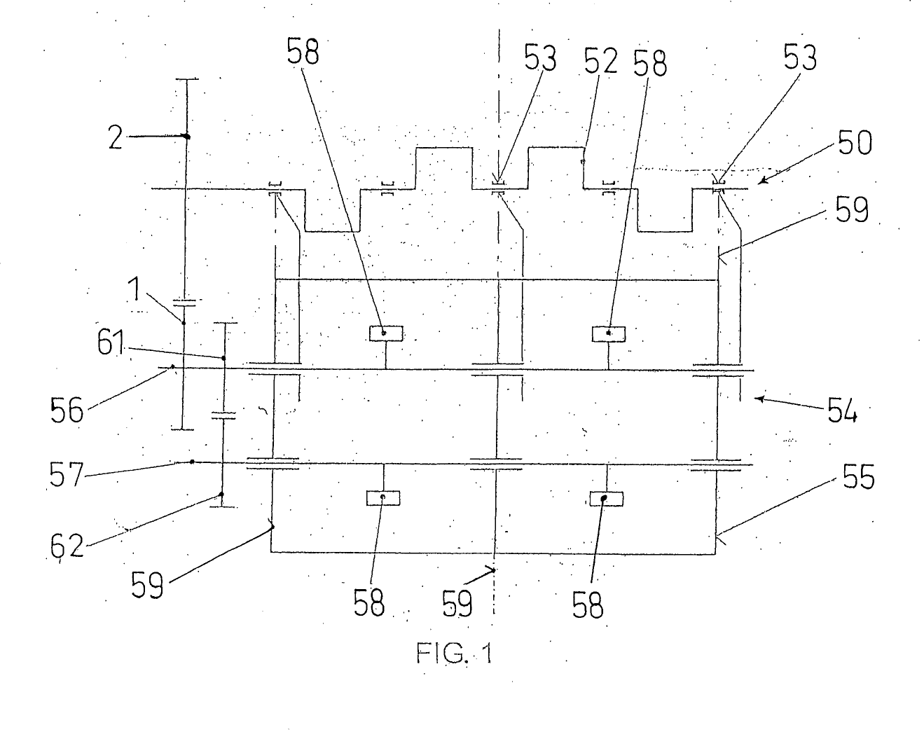

FIG. 1 a diagram of an exemplary mass balancing drive which is driven by means of a gear pairing according to the invention coupled to the crankshaft;

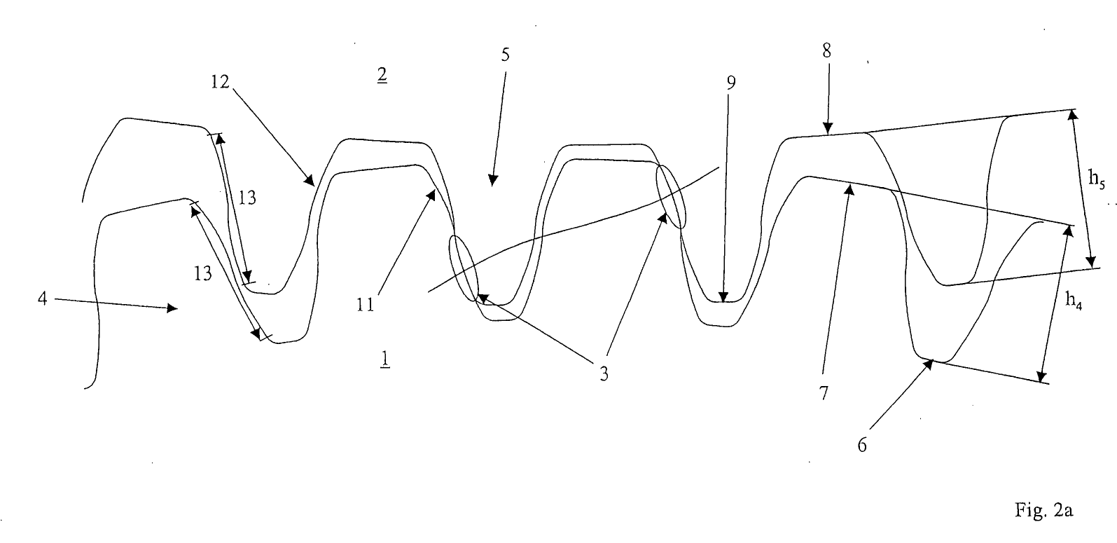

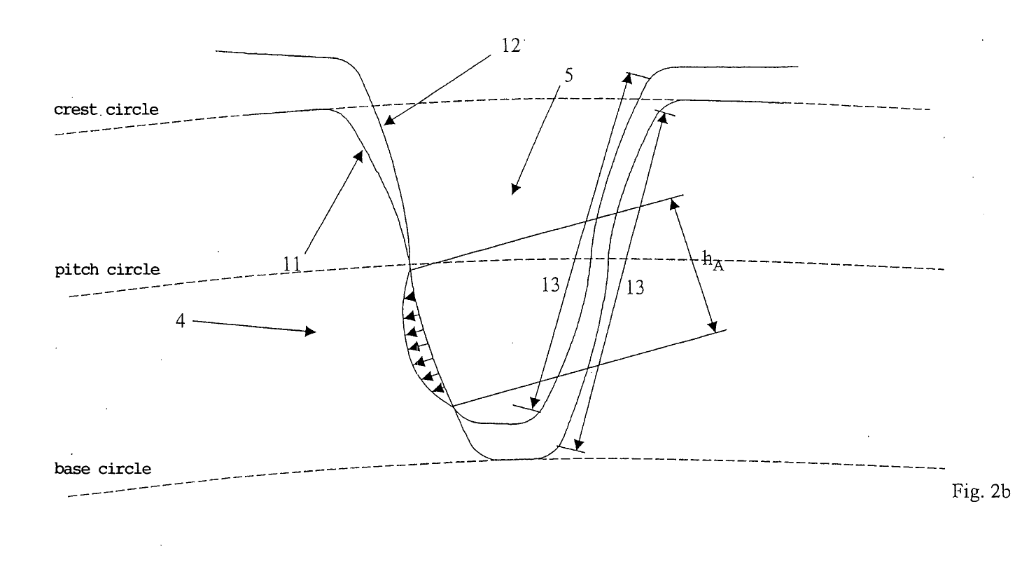

FIG. 2a a gearing design of the gear wheel pairing shown in FIG. 1; and

FIG. 2b an enlarged section of FIG. 2a.

In FIG. 1 the reciprocating piston engine 50 is symbolized only by its crankshaft 50 and the main bearing 53 of the latter. The main bearing 53 represents the entire engine block, which may be implemented either in tunnel design or with free bearing brackets. The mass balancing device attached to the engine block below the crankshaft 52 is designated in general as 54. It consists of a differential case 55, and two balancing shafts 56, 57 with balancing weights 58 rotating in opposite directions inside it. The normal planes 59 are indicated with dashed lines by the main bearings 53. It also contains the bearings of the mass balancing device 54. Balancing shafts 56, 57 are driven via a drive gear 1 by a gear wheel 2 which is connected in a rotationally fixed connection to the crankshaft 52; synchronizing wheels 61, 62 provide for equal speed of the balancing shafts 56, 57 in opposite directions.

FIGS. 2a and 2b show the gear geometry of the tooth pairing of gear wheel 2 and drive gear 1 shown in FIG. 1 in a longitudinal section through the gear wheels. FIG. 2a shows the teeth 5 of metal gear wheel 2, which is situated on the crankshaft, looking from above to below, and looking from below to above the teeth 4 of gear wheel 1, which is situated on balancing shaft 56 and is made of plastic. Teeth 4, 5 are meshed with each other. The heights of teeth 4, 5 are h₄ and h₅, respectively. The height h₄ extends from a base 6 of tooth 4 to its crest 7. The height h₅ extends from a base 8 of tooth 5 to its crest 9. The width of teeth 4,5 changes over the height h₄ or h₅, and is dependent on the shape of the flanks 11, 12 of teeth 4, 5. Reference label 3 identifies the areas in which teeth 4, 5 touch when they are meshed with each other. The entire flank part of a tooth 4, 5, which may come into contact with the flank of the other tooth 5, 4 is designated as the force transmission part, and is identified by reference label 13.

FIG. 2b is an enlarged detail view of FIG. 2a, of the zone in which an area near the crest of a tooth 5 of the metal gear wheel touches an area close to the base of a tooth 4 of the plastic gear wheel. The contact area 3 extends over a height h_{A} of teeth 4, 5. In the area of contact 3, the flank 11 of tooth 4 is concave. The area of tooth 5 which is meshed with tooth flank 11 is convex. The two areas, at least parts of them, have similar or the same curvature, so that they come into contact in an area which is linear when viewed in cross section and in reality is planiform. The effective profiles of tooth flanks 11, 12 of tooth 5 and tooth 4 are coordinated with each other over their entire height h₄, h₅, so that the planiform contacts 3 just described, linear in the cross sectional view according to FIGS. 2a and 2b, occur over the entire height h₄, h₅. In the described exemplary embodiment the flanks 11, 12 of teeth 4, 5 of metal gear wheel 1 and plastic gear wheel 2 each have a concave profile in their area near the base extending to the pitch circle, and a convex profile in their area extending from the pitch circle to near the crown of the tooth. With regard to their curvatures, the profiles are coordinated with each other so that areas which have at least in part similar or the same curvature come into contact with each other when meshing.

The linear or planiform contact 3 has the advantage that the load being transmitted from one gear to the other is distributed over an area, which lowers the load per unit of area. That enables both the wear of gear wheels 1, 2 and the risk of overloading to be reduced substantially. This increases the bearing capability of gear wheels 1, 2 significantly compared to gear wheels with wholly or partially involute toothing, where only dot-shaped contacts occur between the teeth.

As FIG. 2a shows, there are always two, preferably even three pairs of teeth touching each other during the rolling process, so that during roll-off the load does not bear on only a single tooth, but can be distributed equally over three teeth, or with appropriate design also over two or more teeth. The total bearing capacity of the plastic gear wheel is thereby increased.

Although it was stated in the exemplary embodiment discussed above that the first gear wheel is made of plastic and the second gear wheel of metal, the invention is not limited to this configuration. Rather, it is entirely within the scope of the invention to also fabricate the second gear wheel of plastic, but the plastic for the second gear wheel should preferably be of higher strength than the plastic of the first gear wheel. Such a higher strength can be achieved for example by choosing a different plastic, or by mixing in reinforcing additives such as carbon fibers or metal particles.

It must also be noted that the absence of involutes disclosed in the described example between the transition from the concave to the convex flank part of the tooth contour does not necessarily have to be chosen, even though such absence of involutes is ideal. It is also within the scope of the invention for the transition to be at least approximately free of involutes. In that case the involute-free part should be as small as possible, for example less than 10% of the entire flank portion between the highest point of the tooth crest and the lowest point of the tooth base, preferably less than 5% and especially preferred less than 1%.

Finally, it should also be noted that in a preferred embodiment of the invention the form of the tooth flank of the meshing gear wheels should have the following shape. Starting from the crest of the tooth there follows a rounding of the tooth top, which links the tooth crest to the bearing flank. There follows a part of the flank of epicycloidal design, which extends approximately to the pitch circle of the gear wheel and is followed by a part of the flank of hypocycloidal design. The latter extends to the tooth base rounding, which is followed by the tooth base. So with this design the convex portion of the tooth flank, viewed from the interior of a tooth of a gear wheel, is formed by an epicycloidal flank, and the concave portion by a hypocycloidal flank.

What is claimed is:

1. An engine auxiliary drive for a motor vehicle with a toothed-gear drive, that has a first (1) and a second gear wheel (2) with tooth flanks (11, 12) that are meshed with each other, characterized in that the tooth flanks (11, 12) of the gear wheel (1, 2) are free or at least nearly free of involutes in the force transmission area (13), and transition from a concave area directly or at least nearly directly to a convex area, and that the first gear wheel (1) is made of plastic.

2. The engine auxiliary drive according to claim 1, characterized in that the second gear wheel (2) is made of a material with greater strength than the first gear wheel (1).

3. The engine auxiliary drive according to claim 1, characterized in that at least sections of the opposing tooth flanks (11, 12) of gear wheels (1, 2) have nearly the same curvature in their tooth flanks (11, 12).

4. The engine auxiliary drive according to claim 1, characterized in that the concave area is situated in an area adjoining a tooth base (6, 8) and the convex area is situated in an area of the respective teeth (4, 5) adjoining a tooth crest (7, 9).

5. The engine auxiliary drive according to claim 1, characterized in that the second gear wheel (2) is made of metal.

6. The engine auxiliary drive according to claim 5, characterized in that the tooth thickness of the teeth (5) of the gear wheel made of metal (2) is less than the thickness of the teeth (4) of the plastic gear wheel (1).

7. The engine auxiliary drive according to one of claims 1 through 6, claim 1, characterized in that the gear wheel made of plastic (1) has a greater tooth width or tooth thickness on the pitch circle of the gear wheel (1) than the space width.

8. The engine auxiliary drive according to one of claims 1 through 7, claim 1, characterized in that the gear wheel made of metal (2) has a smaller tooth width or tooth thickness on the pitch circle of the gear wheel (2) than the space width.

9. The engine auxiliary drive according to claim 1,
characterized in that during the rolling off of the gear wheels (1, 2) there are always two or more teeth (4, 5) of the gear wheels (1, 2) meshed with each other.

10. The engine auxiliary drive according to claim 1,
characterized in that the plastic gear wheel (1) is an injection molded part that receives no additional treatment after the injection molding.

11. The engine auxiliary drive according to claim 1, characterized in that the gear wheel made of plastic (1) is injection molded onto a hub or a part of a shaft having raised parts and/or depressions on its outer circumference.

12. The engine auxiliary drive according to claim 1, characterized in that it is intended for driving one or more balancing shafts (56, 57).

13. The engine auxiliary drive according to claim 1, characterized in that the first (1) and second (2) gear wheels are designed as helical-toothed spur gears.

14. The engine auxiliary drive according to claim 1, characterized in that the first (1) and second (2) gear wheels are designed as straight-toothed spur gears.

15. The engine auxiliary drive according to claim 1, characterized in that the plastic for the first gear wheel (1) is a homogeneous plastic.
